(19) United States
(12) Patent Application Publication
(10) Pub. No.: US 2020/0246695 A1
(43) Pub. Date: Aug. 6, 2020

(54) GAMING SYSTEM

(71) Applicant: PRIMAX ELECTRONICS LTD., Taipei City (TW)

(72) Inventors: YU-CHIANG LIN, Taipei City (TW); HSIN-JU TENG, Taipei City (TW)

(21) Appl. No.: 16/390,440

(22) Filed: Apr. 22, 2019

(30) Foreign Application Priority Data
Jan. 31, 2019 (TW) 108103889

(51) Int. Cl. A63F 13/327; A63F 13/80; A63F 13/285

(52) U.S. Cl. CPC A63F 13/327; A63F 13/285; A63F 13/80

(57) ABSTRACT

A gaming system includes a computer host, an intelligent judgment module and an auxiliary device. The computer host executes an electronic sports game. The intelligent judgment module is in communication with the computer host. The intelligent judgment module monitors a game information of the electronic sports game. The intelligent judgment module generates an auxiliary signal according to a result of analyzing the game information. The auxiliary device is in wireless communication with the intelligent judgment module. In response to the auxiliary signal, the auxiliary device performs a corresponding prompting operation. The gaming system of the present invention is capable of assisting the user to receive the game information and facilitate the user to play the electronic sports game.

### FIELD OF THE INVENTION

The present invention relates to a gaming system, and more particularly to a gaming system for playing an electronic sports game.

### BACKGROUND OF THE INVENTION

Generally, a basic gaming system comprises a computer host, a computer monitor, a keyboard and a mouse. An electronic sports game can be executed by the computer host. The computer host is in communication with the computer host. A game screen corresponding to the electronic sports game can be shown on the computer monitor so as to be watched by the user. The keyboard and the mouse are in communication with the computer host. The user can operate the keyboard and the mouse to play the electronic sports game.

Since the functions of electronic sports games become more versatile, the user has to operate both of the mouse and the keyboard to play the electronic sports game. Take an electronic sports game “Playerunknown's Battlegrounds” for example. The users have to watch the game screen on the computer monitor with their eyes. Moreover, the users need to watch the game information in the game screen at any time. For example, the user has to observe whether there are game items or enemies in the surrounding environment of the game screen in order to determine to retrieve the game items or shoot the enemies.

In addition to the visual game information, the electronic sports game “Playerunknown's Battlegrounds” also provides the acoustical game information. For example, this electronic sports game provides the sound of the footsteps of the enemies. The user can hear the sound of the enemies' footsteps through headphones and judge the enemies' positions.

In other words, the user has to obtain various kinds of information through the game screen on the computer monitor and the sound from the headphone so as to determine the strategy of playing the game. However, since the game information is usually diverse and huge, the user has to receive too much information. For example, the user needs to pay attention to where there are items to be retrieved, and also needs to pay attention to whether there are enemies nearby. Moreover, when the user concentrates on shooting the enemy, the situation of disregarding the forbidden zone occurs because of the attention shift. Furthermore, there are also some matters that must be paid attention for the specific operation of the electronic sports game. For example, while the user performs the action of throwing a grenade, the electronic sports game “Playerunknown's Battlegrounds” sets that the grenade will explode after 5 seconds after the pin is pulled out. Therefore, the user must pay attention to the surrounding situation and pay attention to whether the throwing time limit exceeds 5 seconds.

Nowadays, mobile phones become essential portable electronic devices for modern people. The incoming call signals or various messages can be received by the mobile phones at any time. While the user plays the electronic sports game, the user must pay attention to the game information of the electronic sports game and pay attention to the mobile phone messages. Under this circumstance, the user may be seriously attacked by the enemy because the user's attention shifts to the mobile phone.

Therefore, there is a need of providing a gaming system capable of assisting the user in receiving the game information.

### SUMMARY OF THE INVENTION

An object of the present invention provides a gaming system including an intelligent judgment module. According to the game information of an electronic sports game, the intelligent judgment module generates a corresponding prompting message to prompt the user that the gaming condition is changed.

Another object of the present invention provides a gaming system including an intelligent judgment module. According to the game information of an electronic sports game, the intelligent judgment module controls a mobile phone to enter a “Do Not Disturb” mode. Consequently, the user can play electronic sports game without being disturbed.

In accordance with an aspect of the present invention, a gaming system is provided. The gaming system includes a computer host, an intelligent judgment module and an auxiliary device. The computer host executes an electronic sports game. The intelligent judgment module is in communication with the computer host. The intelligent judgment module monitors a game information of the electronic sports game. The intelligent judgment module generates an auxiliary signal according to a result of analyzing the game information. The auxiliary device is in wireless communication with the intelligent judgment module. In response to the auxiliary signal, the auxiliary device performs a corresponding prompting operation.

In accordance with another aspect of the present invention, a gaming system is provided. The gaming system includes a computer host, an intelligent judgment module and an auxiliary device. The computer host executes an electronic sports game. The intelligent judgment module is in communication with the computer host. The intelligent judgment module monitors a game information of the electronic sports game. The intelligent judgment module generates an auxiliary signal according to a result of analyzing the game information. The auxiliary device is in wireless communication with the intelligent judgment module and a mobile phone. In response to the auxiliary signal, the auxiliary device issues a corresponding mode-switching signal to the mobile phone. In response to the mode-switching signal, the mobile phone enters a “Do Not Disturb” mode.

From the above descriptions, the present invention provides the gaming system. The intelligent judgment module of the gaming system is used to detect the game screen and the game sound effect corresponding to the electronic sports game. Moreover, the timing of issuing the corresponding auxiliary signal to the auxiliary device by the intelligent judgment module is specially set. According to the auxiliary signal, the auxiliary device performs a corresponding prompting operation. Furthermore, according to the auxiliary signal, the auxiliary device controls the mobile phone to enter the “Do Not Disturb” mode. Consequently, the user can play electronic sports game without being disturbed. Since the gaming system of the present invention is capable of detecting the game screen and the game sound effect corresponding to the electronic sports game, the user's burden is alleviated and the electronic sports game is played smoothly.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating a gaming system according to a first embodiment of the present invention;

FIG. 2 schematically illustrates the auxiliary device of the gaming system according to the first embodiment of the present invention;

FIG. 3 is a schematic functional block diagram illustrating a gaming system according to a second embodiment of the present invention; and

FIGS. 4A and 4B schematically illustrate the auxiliary device of the gaming system according to the second embodiment of the present invention.

### DETAILED DESCRIPTION OF THE PREFERRED EMBODIMENT

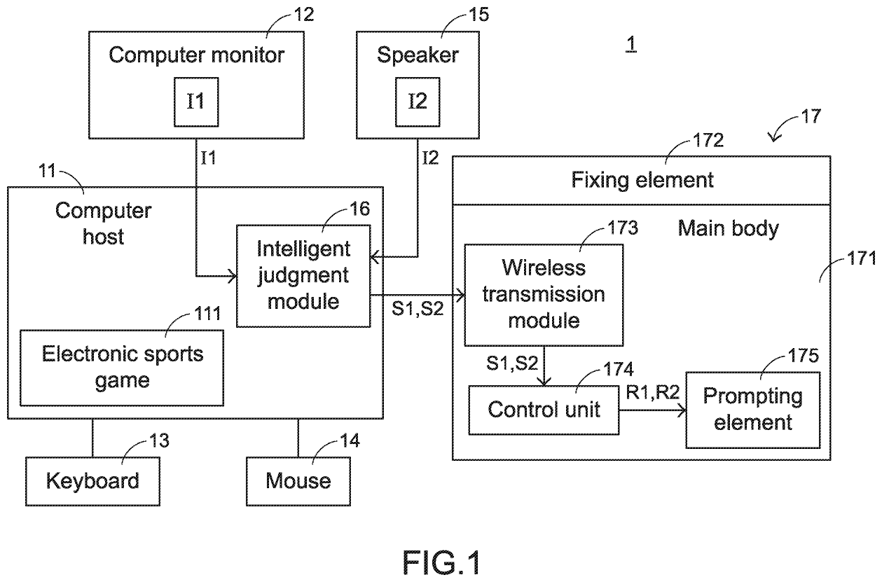

For overcoming the drawbacks of the conventional technologies, the present invention provides a gaming system. FIG. 1 is a schematic functional block diagram illustrating a gaming system according to a first embodiment of the present invention. As shown in FIG. 1, the gaming system 1 comprises a computer host 11, a computer monitor 12, a keyboard 13, a mouse 14, a speaker 15, an intelligent judgment module 16 and an auxiliary device 17.

An electronic sports game 111 is installed in the computer host 11. Moreover, the electronic sports game 111 can be executed by the computer host 11. The computer monitor 12 is in communication with the computer host 11. A first game information I1 of the electronic sports game 111 is shown on the computer monitor 12 in a visual form. For example, the first game information I1 is a game screen corresponding to the electronic sports game 111. The keyboard 13 is in communication with the computer host 11. The user may operate the keyboard 13 to control associated operations of the electronic sports game 111. The mouse 14 is in communication with the computer host 11. Similarly, the user may operate the keyboard 13 to control associated operations of the electronic sports game 111. The speaker 15 is in communication with the computer host 11. A second game information I2 of the electronic sports game 111 is provided by the speaker 15 in an acoustical form. For example, the second game information I2 is a game sound effect corresponding to the electronic sports game 111. In an embodiment, the speaker 15 is a headphone.

The intelligent judgment module 16 is in communication with the computer host 11 and the auxiliary device 17. The intelligent judgment module 16 is used for monitoring the first game information I1 and the second game information I2 of the electronic sports game 111. Moreover, by analyzing the first game information I1 and the second game information I2, the intelligent judgment module 16 generates a first auxiliary signal S1 and a second auxiliary signal S2. In an embodiment, the intelligent judgment module 16 is disposed within the computer host 11 and connected with the auxiliary device 17 in a wireless transmission manner. It is noted that numerous modifications and alterations may be made while retaining the teachings of the invention. For example, in another embodiment, the intelligent judgment module is installed in a cloud server, and the intelligent judgment module is connected with the auxiliary device and the auxiliary device in a wireless transmission manner.

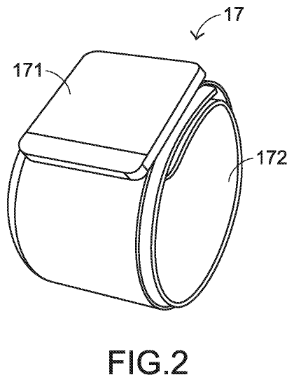

Please refer to FIGS. 1 and 2. FIG. 2 schematically illustrates the auxiliary device of the gaming system according to the first embodiment of the present invention. In this embodiment, the auxiliary device 17 is in wireless communication with the intelligent judgment module 16. The auxiliary device 17 comprises a main body 171, a fixing element 172, a wireless transmission module 173, a control unit 174 and a prompting element 175. The fixing element 172 is combined with the main body 171. Moreover, the fixing element 172 may be sheathed around a portion of the human body of the user (e.g., a wrist). The wireless transmission module 173 is disposed within the main body 171. Moreover, the wireless transmission module 173 is in wireless communication with the intelligent judgment module 16. The wireless transmission module 173 can receive the first auxiliary signal S1 and the second auxiliary signal S2 in the wireless transmission manner. The control unit 174 is disposed within the main body 171. The control unit 174 is in wireless communication with the wireless transmission module 173 to receive the first auxiliary signal S1 and the second auxiliary signal S2. In response to the first auxiliary signal S1 and the second auxiliary signal S2, the control unit 174 issues a first prompting signal R1 and a second prompting signal R2, respectively. In this embodiment, the fixing element 172 has the appearance of a strip-shaped wristband, and thus the auxiliary device 17 can be worn on the wrist of the user by means of the wristband. It is noted that the appearance of the fixing element is not restricted.

The prompting element 175 is disposed within the main body 171 and connected with the control unit 174 to receive the first prompting signal R1 or the second prompting signal R2 from the control unit 174. In response to the first prompting signal R1 or the second prompting signal R2, the prompting element 175 performs a corresponding prompting operation to provide a prompting function to the user. In an embodiment, the control unit 174 is a micro-controller or a control chip, and the prompting element 175 is a vibrator. In other words, the prompting operation of the prompting element 175 is a vibrating action.

Hereinafter, the operations of the gaming system 1 to play the electronic sports game “Playerunknown's Battlegrounds” will be described as follows. When the computer host 11 starts to play the electronic sports game 111, the intelligent judgment module 16 is enabled to acquire the first game information I1 and the second game information I2 of the electronic sports game 111, i.e., the game screen and the game sound effect. In accordance with the present invention, the timing of issuing the first auxiliary signal S1 and the second auxiliary signal S2 by the intelligent judgment module 16 is specially set. If the game screen shows that the pin of the grenade is pulled out, the intelligent judgment module 16 issues the first auxiliary signal S1. Whereas, if the game sound effect corresponding to the enemy's footsteps is detected, the intelligent judgment module 16 issues the second auxiliary signal S2. When the user prepares to throw a grenade, the user may operate the keyboard 13 and the mouse 14 to input a grenade-throwing command. According to the grenade-throwing command, the game screen is changed. That is, the picture of holding a grenade is shown on the game screen. Then, the user inputs a command of pulling out a pin. According to the command, the pin of the grenade is pulled out. Meanwhile, the countdown of the electronic sports game 111 begins.

When the intelligent judgment module 16 detects that the pin of the grenade is pulled out on the game screen, the intelligent judgment module 16 generates the first auxiliary signal S1. The first auxiliary signal S1 is wirelessly transmitted to the auxiliary device 17 that is worn on the user. In the auxiliary device 17, the first auxiliary signal S1 is transmitted to the control unit 174 through the wireless transmission module 173. After the control unit 174 receives the first auxiliary signal S1, the first prompting signal R1 corresponding to the first auxiliary signal S1 is transmitted from the control unit 174 to the prompting element 175. In response to the first prompting signal R1, the prompting element 175 performs a first vibrating action to prompt the user to throw the grenade within a certain time period.

If the enemy is approaching and the game sound effect corresponding to the enemy's footsteps is detected by the intelligent judgment module 16 while the computer host 11 plays the electronic sports game 111, the intelligent judgment module 16 issues the second auxiliary signal S2. The second auxiliary signal S2 is transmitted to the auxiliary device 17. Similarly, the second auxiliary signal S2 is transmitted to the control unit 174. After the control unit 174 receives the second auxiliary signal S2, the second prompting signal R2 corresponding to the second auxiliary signal S2 is transmitted from the control unit 174 to the prompting element 175. In response to the second prompting signal R2, the prompting element 175 performs a second vibrating action to prompt the user that the enemy is approaching. The frequency of the second vibrating action and the frequency of the first vibrating action are different.

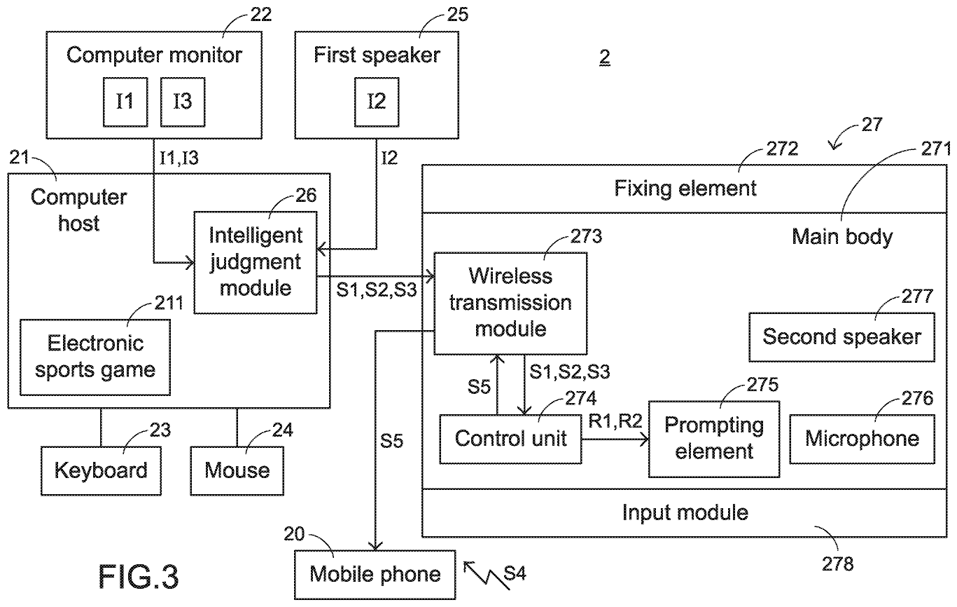

The present invention further provides a second embodiment, which is distinguished from the first embodiment. FIG. 3 is a schematic functional block diagram illustrating a gaming system according to a second embodiment of the present invention. In FIG. 3, the gaming system 2 and a mobile phone 20 of the user are shown. The mobile phone 20 is located near the gaming system 2. As shown in FIG. 3, the gaming system 2 comprises a computer host 21, a computer monitor 22, a keyboard 23, a mouse 24, a first speaker 25, an intelligent judgment module 26 and an auxiliary device 27. The structures and functions of the computer host 21, the computer monitor 22, the keyboard 23, the mouse 24 and the first speaker 25 of this embodiment are substantially identical to the corresponding components of the first embodiment, and are not redundantly described herein. In comparison with the first embodiment, the operations of the intelligent judgment module 26 and the auxiliary device 27 of this embodiment are distinguished.

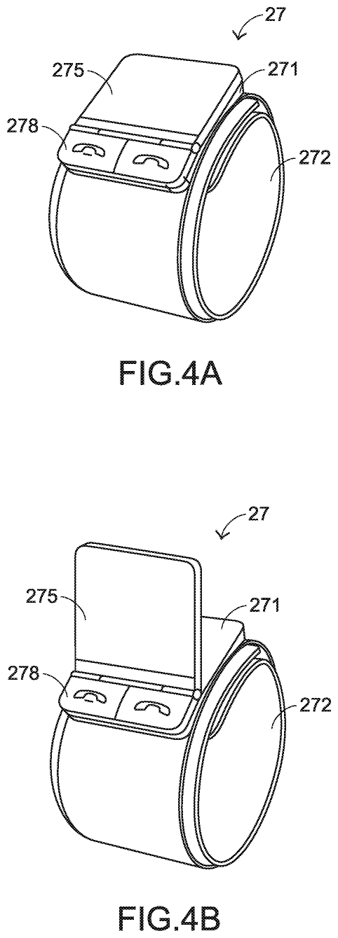

Please refer to FIGS. 3, 4A and 4B. FIGS. 4A and 4B schematically illustrate the auxiliary device of the gaming system according to the second embodiment of the present invention. In this embodiment, the auxiliary device 27 is in wireless communication with the intelligent judgment module 26 and the mobile phone 20. The auxiliary device 27 comprises a main body 271, a fixing element 272, a wireless transmission module 273, a control unit 274, a prompting element 275, a microphone 276, a second speaker 277 and an input module 278. The fixing element 272 is combined with the main body 271. Moreover, the fixing element 272 may be sheathed around a portion of the human body of the user. The wireless transmission module 273 is disposed within the main body 271. Moreover, the wireless transmission module 273 is in wireless communication with the intelligent judgment module 26 and the mobile phone 20. The wireless transmission module 273 can receive a first auxiliary signal S1, a second auxiliary signal S2, a third auxiliary signal S3 in the wireless transmission manner and receives an incoming call signal S4 from the mobile phone 20. The control unit 274 is disposed within the main body 271. The control unit 274 is in wireless communication with the wireless transmission module 273 to receive the first auxiliary signal S1, the second auxiliary signal S2, the third auxiliary signal S3 and the incoming call signal S4. In response to the first auxiliary signal S1, the second auxiliary signal S2 and the third auxiliary signal S3, the control unit 274 issues a first prompting signal R1, a second prompting signal R2 and a mode-switching signal S5, respectively.

The prompting element 275 is disposed within the main body 271 and connected with the control unit 274 to receive the first prompting signal R1 or the second prompting signal R2 from the control unit 274. In response to the first prompting signal R1 or the second prompting signal R2, the prompting element 275 performs a corresponding prompting operation to provide a prompting function to the user. In an embodiment, the prompting element 275 is a display screen. When the prompting operation of the prompting element 275 is performed, a corresponding prompt message is shown on the display screen to be viewed by the user with naked eyes. In a preferred embodiment, the prompting element includes a display screen and a vibrator to provide various prompting operations.

The microphone 276 is disposed within the main body 271 for receiving the sound of the user. The second speaker 277 is also disposed within the main body 271. The second speaker 277 is used for outputting the sound from the mobile phone 20. In other words, the user can make a call through the microphone 276 and the second speaker 277. The input module 278 is disposed on the main body 271 for receiving an input command from the user. According to the input command, the input module 278 accepts the incoming call signal S4 from the mobile phone 20 or declines the incoming call signal S4.

The operations of the gaming system 2 will be described as follows. When the computer host 21 starts to play the electronic sports game 211, the intelligent judgment module 26 is enabled to acquire a first game information I1, a second game information I2 and a third game information I3 of the electronic sports game 211. The first game information I1 and the second game information I2 are similar to those of the first embodiment, and are not redundantly described herein. According to the settings, the intelligent judgment module 26 issues the third auxiliary signal S3 when a low health point event occurs. The low health point event may be defined according to the requirement of the user. If the health point of the game character is low when the electronic sports game 211 is played, the game screen corresponding to the low health point event of the electronic sports game 211 (i.e., the third game information I3) is detected by the intelligent judgment module 26. It is means that the game character of the user is in an emergency condition. Meanwhile, the intelligent judgment module 26 issues the third auxiliary signal S3 to the auxiliary device 27. In the auxiliary device 27, the third auxiliary signal S3 is transmitted to the control unit 274 through the wireless transmission module 273. After the control unit 274 receives the third auxiliary signal S3, the mode-switching signal S5 corresponding to the third auxiliary signal S3 is outputted from the control unit 274. The mode-switching signal S5 is transmitted to the mobile phone 20 through the wireless transmission module 273. In response to the mode-switching signal S5, the mobile phone 20 enters a “Do Not Disturb” mode. Consequently, the user can play electronic sports game 211 without being disturbed.

It is noted that the settings of different mobile phones about the “Do Not Disturb” mode may be different. For example, according to the settings of one mobile phone brand about the “Do Not Disturb” mode, only the incoming call screen and the incoming call message are shown but the sound or vibration is not generated. Whereas, according to the settings of another mobile phone brand about the “Do Not Disturb” mode, all of the incoming signals or messages are rejected. For providing different effects, the “Do Not Disturb” mode may be set according to the mobile phone brands. That is, the settings of the “Do Not Disturb” mode are not restricted as long as the user can play electronic sports game 211 without being disturbed.

On the other hand, if the health point of the game character is not low when the electronic sports game 211 is played, the mobile phone 20 is not forced to enter the “Do Not Disturb” mode. That is, the mobile phone 20 can receive the incoming call signal S4 and the incoming message. In order to prevent the user from diverting the line of sight to the mobile phone 20, the incoming call signal S4 and the incoming message from the mobile phone 20 can be shown on the prompting element 275 of the auxiliary device 27 of the gaming system 2. The user can use the corner of the eye to view the incoming call signal S4 and the incoming message. Moreover, through the input module 278 of the auxiliary device 27, the user can determine whether the incoming call signal S4 is accepted or not. When the incoming call signal S4 is accepted, the user can make a call through the microphone 276 and the second speaker 277 of the auxiliary device 27. In this embodiment, the mechanism of the prompting element 275 is specially designed. As shown in FIG. 4B, the prompting element 275 of the auxiliary device 27 can be uplifted relative to the main body 271. Consequently, the contents shown on the prompting element 275 can be viewed by the user more easily.

From the above descriptions, the present invention provides the gaming system. The intelligent judgment module of the gaming system is used to detect the game screen and the game sound effect corresponding to the electronic sports game. Moreover, the timing of issuing the corresponding auxiliary signal to the auxiliary device by the intelligent judgment module is specially set. According to the auxiliary signal, the auxiliary device performs a corresponding prompting operation. Furthermore, according to the auxiliary signal, the auxiliary device controls the mobile phone to enter the “Do Not Disturb” mode. Consequently, the user can play electronic sports game without being disturbed. Since the gaming system of the present invention is capable of detecting the game screen and the game sound effect corresponding to the electronic sports game, the user's burden is alleviated and the electronic sports game is played smoothly.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A gaming system, comprising:
a computer host executing an electronic sports game;
an intelligent judgment module in communication with the computer host, wherein the intelligent judgment module monitors a game information of the electronic sports game, and the intelligent judgment module generates an auxiliary signal according to a result of analyzing the game information; and
an auxiliary device in wireless communication with the intelligent judgment module, wherein in response to the auxiliary signal, the auxiliary device performs a corresponding prompting operation.

2. The gaming system according to claim 1, wherein the auxiliary device comprises:
a main body;
a fixing element combined with the main body, and sheathed around a portion of a human body of a user;
a wireless transmission module disposed within the main body, wherein the wireless transmission module is in wireless communication with the intelligent judgment module and receives the auxiliary signal;
a control unit disposed within the main body, wherein the control unit is in wireless communication with the wireless transmission module to receives the auxiliary signal, and the control unit issues a prompting signal corresponding to the auxiliary signal; and
a prompting element disposed on the main body, and connected with the control unit to receive the prompting signal, wherein in response to the prompting signal, the prompting element performs the corresponding prompting operation.

3. The gaming system according to claim 2, wherein the prompting element is a display screen, and a prompting message is shown on the display screen when the prompting operation is performed.

4. The gaming system according to claim 2, wherein the prompting element is a vibrator, and a vibrating action is generated by the vibrator when the prompting operation is performed.

5. A gaming system, comprising:
a computer host executing an electronic sports game;
an intelligent judgment module in communication with the computer host, wherein the intelligent judgment module monitors a game information of the electronic sports game, and the intelligent judgment module generates an auxiliary signal according to a result of analyzing the game information; and
an auxiliary device in wireless communication with the intelligent judgment module and a mobile phone, wherein in response to the auxiliary signal, the auxiliary device issues a corresponding mode-switching signal to the mobile phone, wherein in response to the mode-switching signal, the mobile phone enters a “Do Not Disturb” mode.

6. The gaming system according to claim 5, wherein the auxiliary device comprises:
a main body;
a fixing element combined with the main body, and sheathed around a portion of a human body of a user;
a wireless transmission module disposed within the main body, wherein the wireless transmission module is in wireless communication with the intelligent judgment module and the mobile phone and receives the auxiliary signal; and
a control unit disposed within the main body, wherein the control unit is in wireless communication with the wireless transmission module to receives the auxiliary signal, and the control unit issues the mode-switching corresponding to the auxiliary signal.

7. The gaming system according to claim 6, wherein the auxiliary device further comprises a prompting element, which is disposed on the main body, and connected with the control unit to receive a prompting signal from the control unit, wherein in response to the prompting signal, the prompting element performs a corresponding prompting operation.

8. The gaming system according to claim 7, wherein the prompting element is a display screen, and a prompting message is shown on the display screen when the prompting operation is performed.

9. The gaming system according to claim 7, wherein the prompting element is a vibrator, and a vibrating action is generated by the vibrator when the prompting operation is performed.

10. The gaming system according to claim 6, wherein the auxiliary device further comprises:
a microphone;
a speaker; and
an input module disposed on the main body, wherein when the mobile phone receives an incoming call signal and an input command is inputted into the auxiliary device through the input module, the incoming call signal is accepted or the incoming call signal is declined.
